(19) United States
(12) Patent Application Publication
(10) Pub. No.: US 2018/0266320 A1
(43) Pub. Date: Sep. 20, 2018

(54) EXTRACTION COOLING SYSTEM USING EVAPORATIVE MEDIA FOR TURBINE COOLING

(71) Applicant: General Electric Company, Schenectady, NY (US)

(72) Inventors: Naveen Ghattadhahalli PARMESHWAR, Greenville, SC (US); Hua Zhang, Greer, SC (US); Christopher Conrad Frese, Greenville, SC (US); Valery Ivanovich Ponyavin, Greenville, SC (US); Bradly Aaron Kippel, Greer, SC (US)

(21) Appl. No.: 15/463,827

(22) Filed: Mar. 20, 2017

(51) Int. Cl. F02C 7/143; C09K 5/04; F02C 9/18; F01P 3/22

(52) U.S. Cl. CPC F02C 7/143; C09K 5/04; F02W 2746/00138; F01P 3/22; F02C 9/18

(57) ABSTRACT

The present application provides a gas turbine engine. The gas turbine engine may include a compressor, a turbine, an extraction from the compressor to the turbine, and an extraction cooling system in communication with the extraction. The extraction cooling system may include an evaporative cooling media.

### TECHNICAL FIELD

The present application and the resultant patent relate generally to gas turbine engines and more particularly relate to compressor extraction cooling systems using synthetic evaporative media for efficient cooling of hot gas path components and the like.

### BACKGROUND OF THE INVENTION

In a gas turbine engine, hot combustion gases generally flow from a combustor and into a turbine along a hot gas path to produce useful work. Because higher temperature combustion flows generally result in an increase in the performance, the efficiency, and the overall power output of the gas turbine engine, the components that are subject to the higher temperature combustion flows must be cooled to allow the gas turbine engine to operate at such increased temperatures without damage or a reduced lifespan.

A portion of the total airflow from the compressor therefore may be extracted to cool various hot gas path components and the like. The extracted air airflow, however, may not be used in the combustion process to produce useful work. The adequate management and control of these extraction flows therefore may increase the overall performance and efficiency of the gas turbine engine while allowing the gas turbine engine to operate at elevated temperatures.

### SUMMARY OF THE INVENTION

The present application and the resultant patent thus provide a gas turbine engine. The gas turbine engine may include a compressor, a turbine, an extraction from the compressor to the turbine, and an extraction cooling system in communication with the extraction. The extraction cooling system may include an evaporative cooling media therein.

The present application and the resultant patent further provide a method of cooling a turbine in a gas turbine engine. The method may include the steps of taking an extraction from a compressor, passing the extraction through an extraction cooling system, exchanging heat with the extraction and a flow of water in an evaporative cooling media in the extraction cooling system, and flowing the extraction to the turbine.

The present application and the resultant patent further provide a gas turbine engine. The gas turbine engine may include a compressor, a turbine, an extraction from the compressor to the turbine, and an extraction cooling system in communication with the extraction. The extraction cooling system may include a flow of water in an evaporative cooling media.

These and other features and improvements of the present application and the resultant patent will become apparent to one of ordinary skill in the art upon review of the following detailed description when taken in conjunction with the several drawings and the appended claims.

### BRIEF DESCRIPTION OF THE DRAWINGS

FIG. 1 is a schematic diagram of a gas turbine engine with a compressor extraction cooling system as may be described herein.

FIG. 2 is partial sectional view of the extraction cooling system of FIG. 1 with the evaporative cooling medium within an extraction line.

FIG. 3 is a partial sectional view of an alternative embodiment of an extraction cooling system as may be described herein with the evaporative cooling medium surrounding an extraction line.

### DETAILED DESCRIPTION

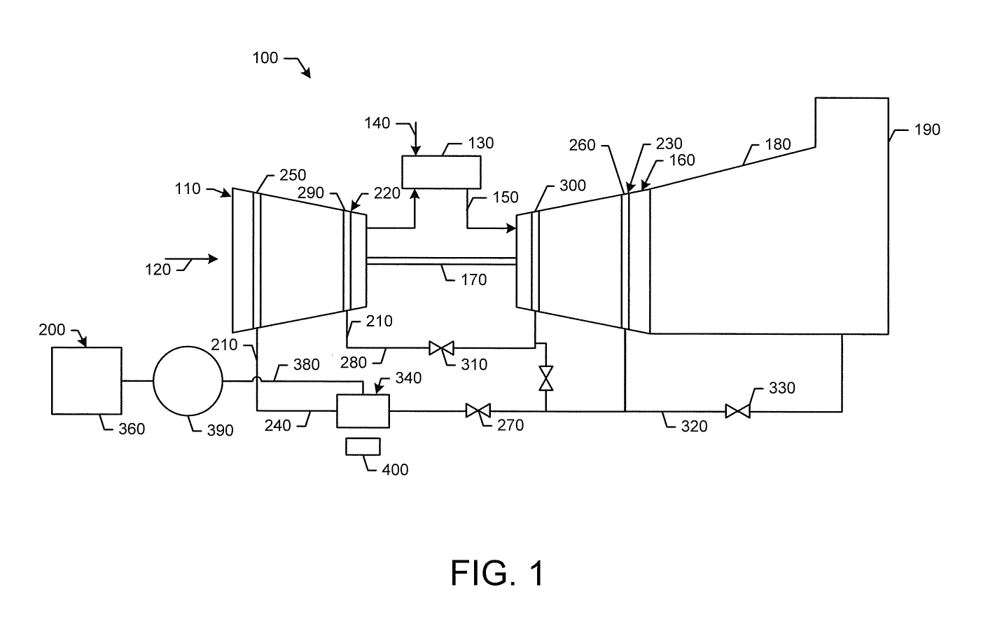

Referring now to the drawings, in which like numerals refer to like elements throughout the several views, FIG. 1 shows a schematic diagram of gas turbine engine 100 as may be used herein. The gas turbine engine 100 may include a compressor 110. The compressor 110 compresses an incoming flow of air 120. The compressor 110 delivers the compressed flow of air 120 to a combustor 130. The combustor 130 mixes the compressed flow of air 120 with a pressurized flow of fuel 140 and ignites the mixture to create a flow of combustion gases 150. Although only a single combustor 130 is shown, the gas turbine engine 100 may include any number of combustors 130 positioned in a circumferential array or otherwise. The flow of combustion gases 150 is in turn delivered to a turbine 160. The flow of combustion gases 150 drives the turbine 160 so as to produce mechanical work. The mechanical work produced in the turbine 160 drives the compressor 110 via a shaft 170 and an external load such as an electrical generator and the like. A diffuser 180 and a stack 190 may be positioned downstream of the turbine 40 for the discharge of the combustion gases 150 or for other purposes.

The gas turbine engine 100 may use natural gas, liquid fuels, various types of syngas, and/or other types of fuels and blends thereof. The gas turbine engine 100 may be any one of a number of different gas turbine engines offered by General Electric Company of Schenectady, New York, including, but not limited to, those such as a Frame 6, 7, or a 9 series heavy duty gas turbine engine and the like. The gas turbine engine 10 may have different configurations and may use other types of components. Other types of gas turbine engines also may be used herein. Multiple gas turbine engines, other types of turbines, and other types of power generation equipment also may be used herein together.

The gas turbine engine 100 may be part of a combined cycle system (not shown). Generally described in a typical combined cycle system, the flow of hot exhaust gases from the turbine 160 may be in communication with a heat recovery steam generator or other type of heat exchange device. The heat recovery steam generator, in turn, may be in communication with a multi-stage steam turbine and the like so as to drive a load. The load may be same load driven by the gas turbine engine 100 or a further load or other type of device. Other components and other configurations also may be used herein.

The gas turbine engine 100 may include an extraction cooling system 200. The extraction cooling system 200 may use a number of air extractions 210 from the compressor 110 cool the turbine 160 or other hot gas path components. Specifically, the compressor 110 may include a number of compressor stages 220 therein. Likewise, the turbine 160 also may have any number of turbine stages 230 therein. The gas turbine engine 100 thus may use a number of the air extractions 210 to provide cooling air from the compressor 110 to the turbine 160. In this example, a first extraction line 240 may extend from a ninth stage 250 of the compressor 110 to a third stage 260 of the turbine 160. A first extraction line control valve 270 may be positioned thereon. Likewise, the gas turbine engine 100 may have a second extraction line 280 extending from a thirteenth stage 290 of the compressor 110 to a second stage 300 of the turbine 160. A second extraction line control valve 310 may be positioned thereon. The third extraction line 320 may extend from downstream of the second extraction line 280 or elsewhere. The third extraction line 320 may be used to cool other types of gas turbine components. In this example, the third extraction line 320 may be used to cool the stack 190. A third extraction line control valve 330 may be positioned thereon. Other types of air extractions may be used herein in any number and any configuration.

The extraction cooling system 210 may include an evaporative media cooling system 340 positioned about one or more of the extraction lines 240, 280, 320, or elsewhere. The evaporative media cooling system 340 may use a synthetic evaporative cooling media 350 to cool the flow of the extractions 210. The synthetic evaporative cooling media 350 may be thermally formed from non-woven synthetic fibers with or without hydrophilic surface enhancements. For example, the non-woven synthetic fibers may include polyethylene terephthalate (PET), polytrimethylene terephthalate (PTT), nylon, polyester, polypropylene, and the like. The hydrophilic surface enhancements may include the application of a strong alkaline treatment under high processing temperatures, polyvinyl alcohol in an alkaline medium, and the like. Other materials and treatments may be used herein. The synthetic evaporative cooling media 350 may be wetable so as to accept, absorb, flow, and distribute a flow of water or other type of heat exchange medium through the surface area thereof.

The extraction cooling system 210 may include a water source 360 with a flow of water 370 or other type of heat exchange medium therein. The water source 360 may be in communication with the synthetic evaporative cooling media 350 via a cooling line 380 and one or more cooling pumps 390. Other types of fluid movement devices may be used herein. A drain 400 optionally may be used. Other components and other configurations may be used herein.

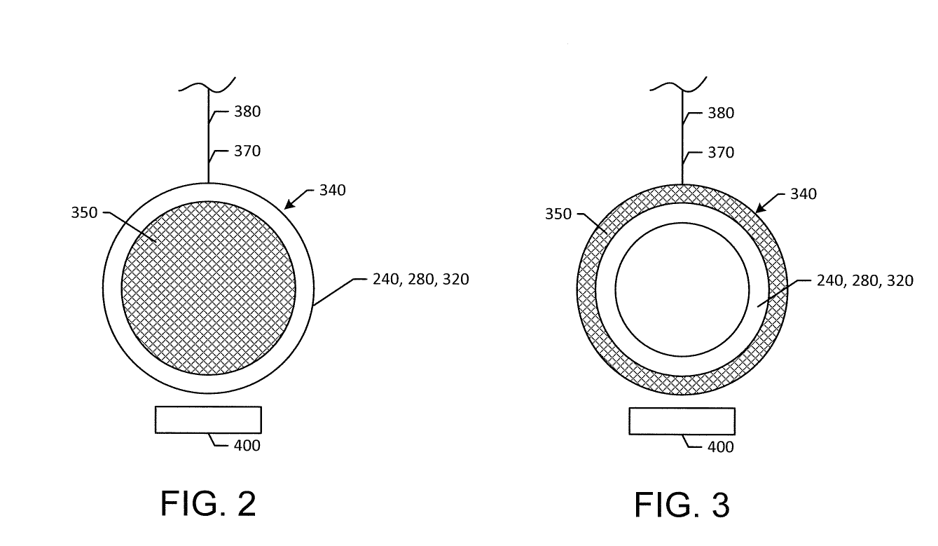

In an example shown in FIG. 2, the synthetic evaporative cooling media 350 may be positioned within one of the extraction lines 240, 280, 320. The flow of water 370 from the water source 360 may flow through the cooling line 380 to the top of the synthetic evaporative cooling media 350 and may be drained from the bottom into the drain 400 or otherwise. The synthetic evaporative cooling media 350 promotes heat exchange between the hot extraction air flow and the flow of the water 370 or other heat exchange medium. Alternatively, the drain 400 may not be required because the flow of water 370 may largely evaporate in the extraction air flow. In the example of FIG. 3, the synthetic evaporative cooling media 350 may be wrapped around the outside to the extraction lines 240, 280, 320. Other components and other configurations may be used herein.

The compressor extractions 210 may have appropriate dampers, blowers, and the like as well as internal baffles to minimize back pressure so as to achieve overall gas temperature uniformity. A number of control valves, control sensors, temperature sensors, and other types of controls and sensors may be used herein. Overall operations of the extraction cooling system 200 may be controlled by the overall gas turbine control (e.g., a “GE Speedtronic” controller or a similar device) or a dedicated controller per the optimization logic. (“Speedtronic” is a trademark of the General Electric Company of Schenectady, New York.) Other components and other configurations may be used herein.

In use, the extractions 210 have been bled from the compressor 110 at about 700 degrees Fahrenheit (about 371 degrees Celsius) and used to cool hot gas path components that may be at about 1400 degrees Fahrenheit (about 760 degrees Celsius). The use of the extraction cooling system 200 cools the extractions 210 such that higher firing temperatures may be accommodated. Specifically, the first extraction line 240 may direct an extraction 210 from the ninth compressor stage 250 to the third turbine stage 260. The extraction cooling system 200 may cool the extraction 210 by heat exchange with the flow of water 370 passing through the synthetic evaporative cooling media 350. The extraction cooling system 200 likewise may cool the extraction in the second extraction line 280 extending from the thirteen compressor stage 290 to the second turbine stage 300. As described above, the synthetic evaporative cooling media 350 may be positioned within or about the extraction lines 240, 280. Other components and other configurations may be used herein.

The use of the extraction cooling system 200 thus may improve emissions turndown capability, may provide improved cooling to the nozzles, buckets, cavities, and other components in the hot gas path, and may avoid aeromechanical stall during startup and shutdown. Moreover, the extraction cooling system 200 may provide an extended lifetime for the hot gas path components given the overall lower temperatures even with increased firing temperatures.

In addition to cooling the turbine 160, the extraction cooling system 200 may be used to cool extractions 160 directed elsewhere. For example, the third extraction line 320 may deliver an extraction to the stack 190 or other portion of the overall exhaust system. The delivery of a cooled extraction 160 may permit increased firing temperatures without requiring a retrofit of the stack 190 and the like that would otherwise be required to withstand the higher exhaust isotherms. The accommodation of the higher temperatures applies to part load operations as well as extended turndown operations. Other portions of the overall gas turbine engine 100 may be cooled in a similar manner.

It should be apparent that the foregoing relates only to certain embodiments of the present application and the resultant patent. Numerous changes and modifications may be made herein by one of ordinary skill in the art without departing from the general spirit and scope of the invention as defined by the following claims and the equivalents thereof.

We claim:

1. A gas turbine engine, comprising:
a compressor;
a turbine;
an extraction from the compressor to the turbine; and
an extraction cooling system in communication with the extraction;
wherein the extraction cooling system comprises an evaporative cooling media.

2. The gas turbine engine of claim 1, wherein the evaporative cooling media comprises a synthetic evaporative cooling media.

3. The gas turbine engine of claim 1, wherein the evaporative cooling media comprises polyethylene terephthalate (PET), polytrimethylene terephthalate (PTT), nylon, polyester, or polypropylene.

4. The gas turbine engine of claim 1, wherein the extraction cooling system comprises a flow of water in communication with the evaporative cooling media.

5. The gas turbine engine of claim 1, wherein the extraction comprises an extraction line extending from the compressor.

6. The gas turbine engine of claim 5, wherein the evaporative cooling media is positioned within the extraction line.

7. The gas turbine engine of claim 5, wherein the evaporative cooling media surrounds the extraction line in whole or in part.

8. The gas turbine engine of claim 5, wherein the extraction line comprises a valve thereon.

9. The gas turbine engine of claim 1, wherein the extraction cooling system comprises a drain downstream of the evaporative cooling media.

10. The gas turbine engine of claim 1, wherein the extraction cooling system comprises a pump in communication with a water source.

11. The gas turbine engine of claim 1, wherein the extraction extends from a compressor stage to a turbine stage.

12. The gas turbine engine of claim 1, wherein the extraction extends from a ninth compressor stage to a third turbine stage.

13. The gas turbine engine of claim 1, wherein the extraction extends from a thirteen compressor stage to a second turbine stage.

14. The gas turbine engine of claim 1, further comprising a plurality of extractions from the compressor to the turbine.

15. A method of cooling a turbine in a gas turbine engine, comprising:
taking an extraction from a compressor;
passing the extraction through an extraction cooling system;
exchanging heat with the extraction and a flow of water in an evaporative cooling media in the extraction cooling system; and
flowing the extraction to the turbine.

16. A gas turbine engine, comprising:
a compressor;
a turbine;
an extraction from the compressor to the turbine; and
an extraction cooling system in communication with the extraction;
wherein the extraction cooling system comprises a flow of water in an evaporative cooling media.

17. The gas turbine engine of claim 16, wherein the evaporative cooling media comprises a synthetic evaporative cooling media.

18. The gas turbine engine of claim 16, wherein the evaporative cooling media comprises polyethylene terephthalate (PET), polytrimethylene terephthalate (PTT), nylon, polyester, or polypropylene.

19. The gas turbine engine of claim 16, wherein the extraction comprises an extraction line extending from the compressor and wherein the evaporative cooling media is positioned within the extraction line.

20. The gas turbine engine of claim 16, wherein the extraction comprises an extraction line extending from the compressor and wherein the evaporative cooling media surrounds the extraction line in whole or in part.
